(19) United States
(12) Patent Application Publication
(10) Pub. No.: US 2009/0173411 A1
(43) Pub. Date: Jul. 9, 2009

(54) FLITCH PLANER

(76) Inventors: Jürgen F. Trost, Columbiana, OH (US); Daniel J. Rastatter, Beaver Falls, PA (US); Benjamin D. Smith, Abbeville, AL (US); Harold Wayne Fleming, Columbia, AL (US); A. Scott Mcinnis, Headland, AL (US); David E. Seffens, Crestview, FL (US); Gregory G. Chandler, Orlando, FL (US); Carl D. Shore, Pace, FL (US)

Correspondence Address: BARNES & THORNBURG LLP, 11 SOUTH MERIDIAN, INDIANAPOLIS, IN, 46204, US

(21) Appl. No.: 12/090,390

(22) PCT Filed: Nov. 7, 2006
(86) PCT No.: PCT/US2006/043393

§ 371 Date: Oct. 1, 2008

Related U.S. Application Data
(60) Provisional application No. 60/734,943, filed on Nov. 9, 2005.

(51) Int. Cl. B27C 1/00

(52) U.S. Cl. 144/392; 144/134.1; 144/250.13; 144/245.2; 144/1.1

(57) ABSTRACT

Apparatus for shaping a flitch includes an upper shaping head assembly for shaping an upper surface of the flitch, a lower shaping head assembly for shaping a lower surface of the flitch, and a groover assembly for placing at least one groove in a surface of the flitch. The apparatus further includes at least one centering arm and chain runner assembly. The at least one centering arm and chain runner assembly includes a chain runner assembly for conveying the flitch toward a transverse center of the centering arm and chain runner assembly, and a centering arm assembly for positioning the flitch. A flitch transport conveyor includes a conveyor frame, a first dogger arm assembly for engaging a first end of the flitch, and a second dogger arm assembly for engaging a second end of the flitch.

### CROSS-REFERENCE TO RELATED APPLICATION

This application claims the benefit under 35 U.S.C. § 119(e) of U.S. provisional patent application Ser. No. 60/734,943, filed 9 Nov. 2005, the entirety of the disclosure of which is incorporated herein by reference.

### FIELD OF THE INVENTION

This invention relates to planing and shaping equipment. It is disclosed in the context of a planer for shaping flitches, longitudinal cuts from the trunks of trees. However, it is believed to be useful in other applications as well.

### BACKGROUND OF THE INVENTION

Various types of planers for shaping flitches are known. There are, for example, the flitch planers illustrated and described in U.S. Pat. No. 6,474,379, WO 03/070440, and U.S. published patent application 2005-0121106-A1, and references cited therein. No representation is intended by this listing that a thorough search of all material prior art has been conducted, or that no better art than that listed is available. Nor should any such representation be inferred. The disclosures of all of the above are hereby incorporated herein by reference.

### DISCLOSURE OF THE INVENTION

According to an aspect of the invention, apparatus for shaping a flitch includes a first shaping head assembly for shaping a first surface of the flitch, a second shaping head assembly for shaping a second surface of the flitch, and a groover assembly for placing at least one groove in a surface of the flitch.

Further illustratively according to this aspect of the invention, the apparatus includes a control system for providing a shaping solution and controlling the apparatus in accordance with the shaping solution to shape the flitch.

Further illustratively according to this aspect of the invention, the apparatus includes a first frame assembly for supporting the first shaping head assembly, the second shaping head assembly, and the groover assembly, and a second frame assembly. The first and second frame assemblies together comprise at least one slideway which extends in the directions of motion of the first frame assembly, and at least one bearing engaging the at least one slideway.

Illustratively according to this aspect of the invention, the at least one bearing is provided on the first frame assembly.

Further illustratively according to this aspect of the invention, the apparatus comprises a motor coupled between the second frame assembly and the first frame assembly and actuable to shift the first frame assembly transversely of the direction of motion of the flitch through the apparatus.

Illustratively according to this aspect of the invention, the first shaping head assembly is mounted to the first frame assembly by at least one slideway, at least one bearing slidable on the at least one slideway, and an actuator mounting assembly coupled between the first frame assembly and the first shaping head assembly to maintain the first shaping head assembly in a desired position to shape the flitch.

Further illustratively according to this aspect of the invention, the apparatus includes a press roll assembly mounted to the first shaping head assembly and a motor for maintaining a desired pressure on the flitch as the flitch passes the press roll assembly.

Illustratively according to this aspect of the invention, the second shaping head assembly is mounted to the first frame assembly by at least one slideway, at least one bearing slidable on the at least one slideway, and an actuator mounting assembly coupled between the first frame assembly and the second shaping head assembly to maintain the second shaping head assembly in a desired position for shaping the flitch.

Illustratively according to this aspect of the invention, the groover assembly is mounted to the first frame assembly by at least one slideway, at least one bearing slidable on the at least one slideway, and an actuator mounting assembly coupled between the first frame assembly and the groover assembly to maintain the groover assembly in a desired position for placing at least one groove in a surface of the flitch.

Further illustratively according to this aspect of the invention, the apparatus comprises a motor to control the first frame assembly and the groover assembly so that when the groover assembly is grooving a flitch, the first frame assembly moves transversely of the direction of motion of the flitch past the groover assembly.

Illustratively according to this aspect of the invention, the first shaping head assembly is mounted to the first frame assembly by at least one slideway and at least one bearing. An actuator mounting assembly is coupled between the first frame assembly and the first shaping head assembly to maintain the first shaping head assembly in a desired position to shape the flitch.

According to another aspect of the invention, apparatus for conveying a flitch includes at least one centering arm and chain runner assembly. The at least one centering arm and chain runner assembly includes a chain runner assembly for conveying the flitch toward a transverse center of the centering arm and chain runner assembly. The at least one centering arm and chain runner assembly further includes a centering arm assembly for positioning the flitch.

Further illustratively according to this aspect of the invention, the apparatus includes at least one slide assembly, a slide frame for supporting the slide assembly, and a motor assembly for positioning at least a portion of the centering arm and chain runner assembly with respect to at least another portion of the centering arm and chain runner assembly.

Illustratively according to this aspect of the invention, the apparatus includes first and second centering arm and chain runner assemblies. Each of the first and second centering arm and chain runner assemblies includes a chain runner assembly for conveying the flitch toward a transverse center of the centering arm and chain runner assembly, a centering arm assembly for positioning the flitch, a slide assembly, a slide frame for supporting the slide assembly, and a lift motor assembly.

Illustratively according to this aspect of the invention, a first one of the slide frames is mounted on a slide base assembly for movement toward and away from a second one of the slide frames.

Illustratively according to this aspect of the invention, the first one of the slide frames is mounted on a slide base assembly.

Illustratively according to this aspect of the invention, one of the first slide frame and the slide base includes at least one slideway and the other of the first slide frame and the slide base includes at least one bearing for engaging the slideway for movably mounting the first slide frame on the slide base.

Further illustratively according to this aspect of the invention, the apparatus includes a chain runner assembly for moving the first one of the slide frames toward and away from the second one of the slide frames. The chain runner assembly includes an idler assembly mounted beyond a first limit of movement of the slide base and a drive assembly mounted beyond a second limit of movement of the slide base.

Illustratively according to this aspect of the invention, the motor assembly comprises a plurality of fluid cylinders. Actuation of a selected one or selected ones of the plurality of fluid cylinders permits at least a portion of the centering arm and chain runner assembly to be moved with respect to at least another portion of the centering arm and chain runner assembly a selected distance of multiple different distances.

Further illustratively according to this aspect of the invention, the apparatus includes at least one slide assembly, a slide frame for supporting the slide assembly, a slideway mounted to one of the slide assembly and slide frame, and at least one bearing mounted to the other of the slide assembly and slide frame to permit relative movement between the slide assembly and slide frame.

Further illustratively according to this aspect of the invention, the apparatus includes a motor assembly coupled between the slide frame and the slide assembly. Actuation of the motor assembly reciprocates the slide assembly with respect to the slide frame.

Illustratively according to this aspect of the invention, the centering arm and chain runner assembly includes a support, a drive sprocket, a driven sprocket, a drive motor, and a chain trained about the drive sprocket and driven sprocket. The chain is selectively driven by the drive motor to move the flitch along the centering arm and chain runner assembly.

Illustratively according to this aspect of the invention, the support comprises a tubular support rotatably supporting the drive sprocket and the driven sprocket in spaced-apart orientation. The tubular support includes a wall defining an inside and an outside. The chain is trained about the sprockets with a first bight of the chain extending outside the wall and a second bight of the chain extending inside the wall.

Illustratively according to this aspect of the invention, the centering arm and chain runner assembly comprises two centering arms. Each centering arm includes gear teeth. A frame pivotally supports the centering arms with their gear teeth in engagement to synchronize their motion. A motor is provided for moving the centering arms between centering and releasing orientations.

Illustratively according to this aspect of the invention, the motor comprises a piston-and-cylinder fluid motor.

According to another aspect of the invention, a flitch transport conveyor includes a conveyor frame, a first dogger arm assembly for engaging a first end of the flitch and a second dogger arm assembly for engaging a second end of the flitch.

Illustratively according to this aspect of the invention, the conveyor frame includes a first slideway and a second slideway. Each dogger arm assembly includes at least one bearing for engaging the first slideway, and a slide bar for engaging the second slideway.

Further illustratively according to this aspect of the invention, the apparatus includes a first drive system for driving the first dogger arm assembly along the conveyor frame and a second drive system for driving the second dogger arm assembly along the conveyor frame.

Illustratively according to this aspect of the invention, each of the first and second drive systems includes a drive chain, a drive sprocket, an idler sprocket, and a drive motor. The drive chains are coupled to respective ones of the first and second dogger arm assemblies and extend about respective ones of the drive and idler sprockets.

According to another aspect of the invention, apparatus for shaping a flitch includes a first shaping head assembly for shaping a first surface of the flitch, a second shaping head assembly for shaping a second surface of the flitch, and a control system for providing a shaping solution and controlling the apparatus in accordance with the shaping solution to shape the flitch.

Illustratively according to this aspect of the invention, the control system includes a scanner for scanning the flitch before shaping the flitch. The control system provides the shaping solution to optimize the yield from the flitch.

According to another aspect of the invention, apparatus for shaping a flitch includes a first shaping head assembly for shaping a first surface of the flitch, a second shaping head assembly for shaping a second surface of the flitch, a first frame assembly for supporting the first and second shaping head assemblies, and a second frame assembly. The first and second frame assemblies together comprise at least one slideway which extends in the directions of motion of the first frame assembly. The apparatus further includes at least one bearing engaging the at least one slideway.

Illustratively according to this aspect of the invention, the at least one bearing is provided on the first frame assembly.

Further illustratively according to this aspect of the invention, the apparatus comprises a motor coupled between the first and second frame assemblies and actuable to shift the first frame assembly transversely of the direction of motion of the flitch through the apparatus.

According to another aspect of the invention, apparatus for shaping a flitch includes a shaping head assembly for shaping a surface of the flitch, and a frame assembly. The shaping head assembly is mounted to the frame assembly by at least one slideway. At least one bearing is slidable on the at least one slideway. An actuator mounting assembly is coupled between the frame assembly and the shaping head assembly to maintain the shaping head assembly in a desired position to shape the flitch.

Further illustratively according to this aspect of the invention, the apparatus includes a press roll assembly mounted to the shaping head assembly and a motor for maintaining a desired pressure on the flitch as the flitch passes the press roll assembly.

According to another aspect of the invention, apparatus for shaping a flitch includes a first shaping head assembly for shaping a first surface of the flitch, a second shaping head assembly for shaping a second surface of the flitch, and a frame assembly. The first shaping head assembly is mounted to the frame assembly by at least one slideway and at least one bearing. An actuator mounting assembly is coupled between the frame assembly and the first shaping head assembly to maintain the first shaping head assembly in a desired position to shape the flitch.

According to another aspect of the invention, apparatus for shaping a flitch includes a first shaping head assembly for shaping a first surface of the flitch, and a control system for providing a shaping solution and controlling the apparatus in accordance with the shaping solution to shape the flitch. A flitch transport conveyor includes a first dogger arm assembly for engaging a first end of the flitch and a second dogger arm assembly for engaging a second end of the flitch to convey the flitch past the first shaping head assembly.

Illustratively according to this aspect of the invention, the flitch transport conveyor includes a conveyor frame. The conveyor frame includes a first slideway and a second slideway. Each dogger arm assembly includes at least one bearing for engaging the first slideway and a slide bar for engaging the second slideway. First and second drive systems drive the first and second dogger arm assemblies, respectively, along the conveyor frame.

Illustratively according to this aspect of the invention, each of the first and second drive systems includes a drive chain, a drive sprocket, an idler sprocket, and a drive motor. The drive chains are coupled to respective ones of the first and second dogger arm assemblies and extend about respective ones of the drive and idler sprockets.

Illustratively according to this aspect of the invention, the apparatus includes a second shaping head assembly for shaping a second surface of the flitch.

Illustratively according to this aspect of the invention, the control system includes a scanner for scanning the flitch before shaping the flitch. The control system provides the shaping solution to optimize the yield from the flitch. The flitch transport conveyor conveys the flitch first through the scanner to provide a shaping solution for the flitch and then past the first and second shaping heads to implement the shaping solution.

### BRIEF DESCRIPTION OF THE DRAWINGS

The invention may best be understood by referring to the following detailed description and accompanying drawings which illustrate the invention. In the drawings:

FIGS. 1a-c illustrate a top plan view of a system incorporating a flitch planer constructed according to the invention;

FIGS. 2a-d, respectively, illustrate a side elevational view (FIG. 2a) of a scanner housing illustrated in FIG. 1b, an end elevational view (FIG. 2b) of the scanner housing illustrated in FIG. 2a, taken from the downstream, or exit, end of the scanner housing, a top plan view (FIG. 2c) of the scanner housing illustrated in FIGS. 1b, 2a and 2b, and a side elevational view (FIG. 2d), viewed from the side opposite the side illustrated in FIG. 2a;

FIG. 3 illustrates a diagrammatic end elevational view of the scanner housing illustrated in FIGS. 1b and 2a-d, with the sidewall removed to illustrate possible locations of scanners in the housing;

FIGS. 4a-d illustrate an end elevational view, viewed from the upstream, or entry, end (FIGS. 4a-b), of the planing or shaping section illustrated in FIG. 1b, a side elevational view, from the conveyor side (FIG. 4c), of the planing or shaping section illustrated in FIGS. 1b and 4a-b, and an end elevational view, viewed from the downstream, or exit, end (FIG. 4d), of the planing or shaping section illustrated in FIGS. 1b and 4a-c;

FIGS. 5a-f illustrate a side elevational view (FIG. 5a) of a lifting conveyor section illustrated in FIG. 1a, a top plan view (FIG. 5b) of the lifting conveyor section illustrated in FIGS. 1a and 5a, a side elevational view of a detail of the lifting conveyor section illustrated in FIGS. 1a and 5a-b, a top plan view (FIG. 5d) of the detail illustrated in FIG. 5c, an end elevational view (FIG. 5e), from the downstream end of the conveyor, of the detail illustrated in FIGS. 5c-d, and an end elevational view (FIG. 5f) of another detail of the lifting conveyor section illustrated in FIGS. 1a and 5a-b;

FIGS. 6a-b illustrate a top plan view (FIG. 6a) and an end elevational view (FIG. 6b) of a detail of the conveyor illustrated in FIGS. 1a-c;

FIGS. 7a-b illustrate a top plan view (FIG. 7a) and an end elevational view (FIG. 7b) of a detail of the conveyor illustrated in FIGS. 1a-c; and,

FIGS. 8a-d, 9a-c and 10a-e illustrate sequential function charts (hereinafter sometimes SFCs) useful in understanding the invention.

### DETAILED DESCRIPTIONS OF ILLUSTRATIVE EMBODIMENTS

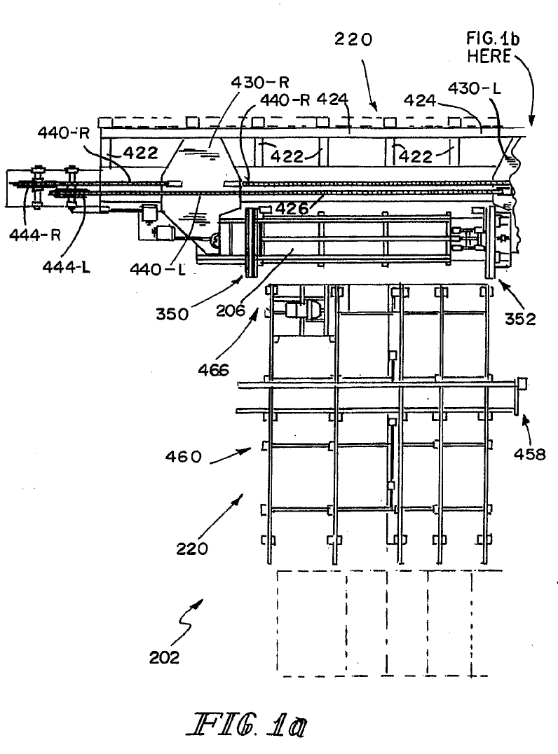

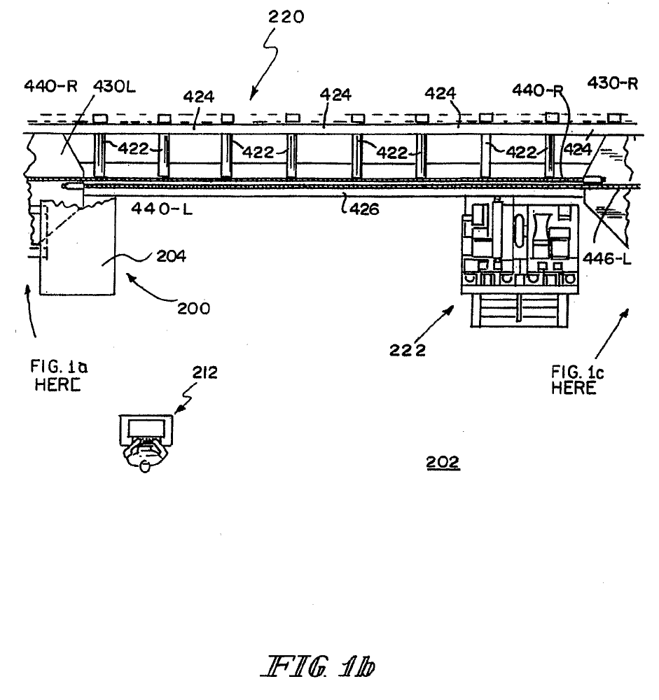

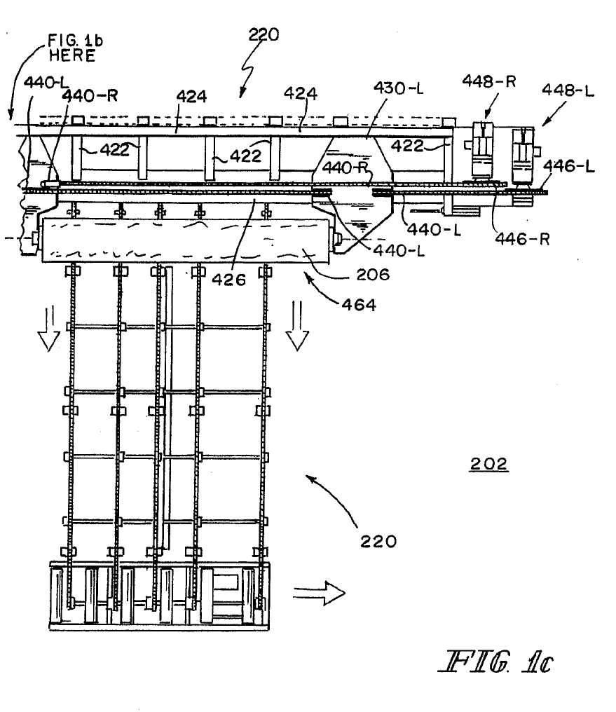

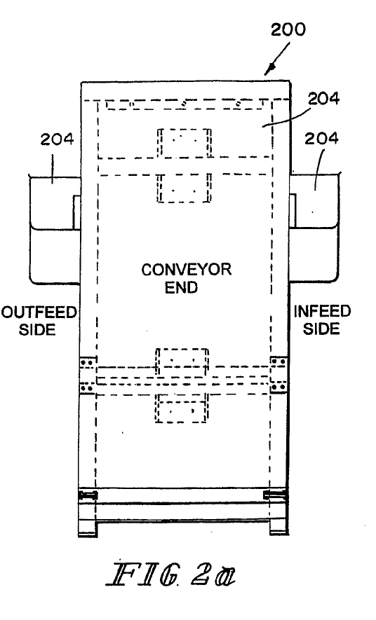

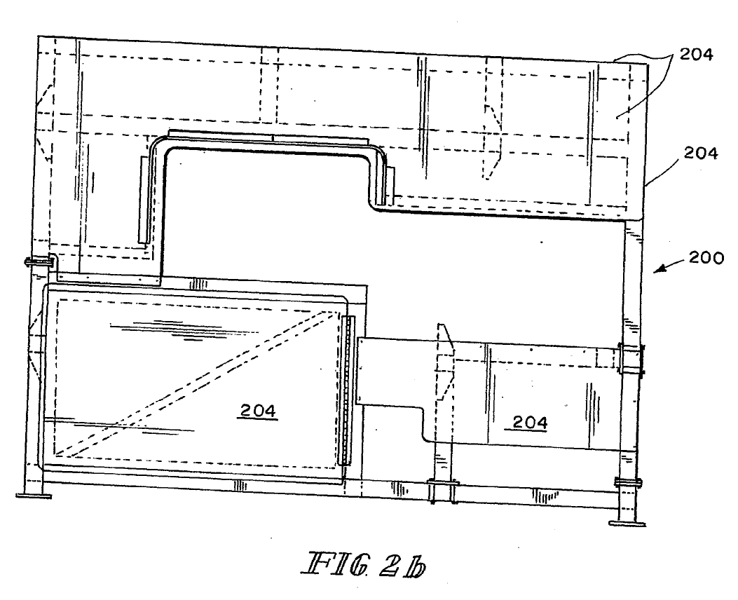

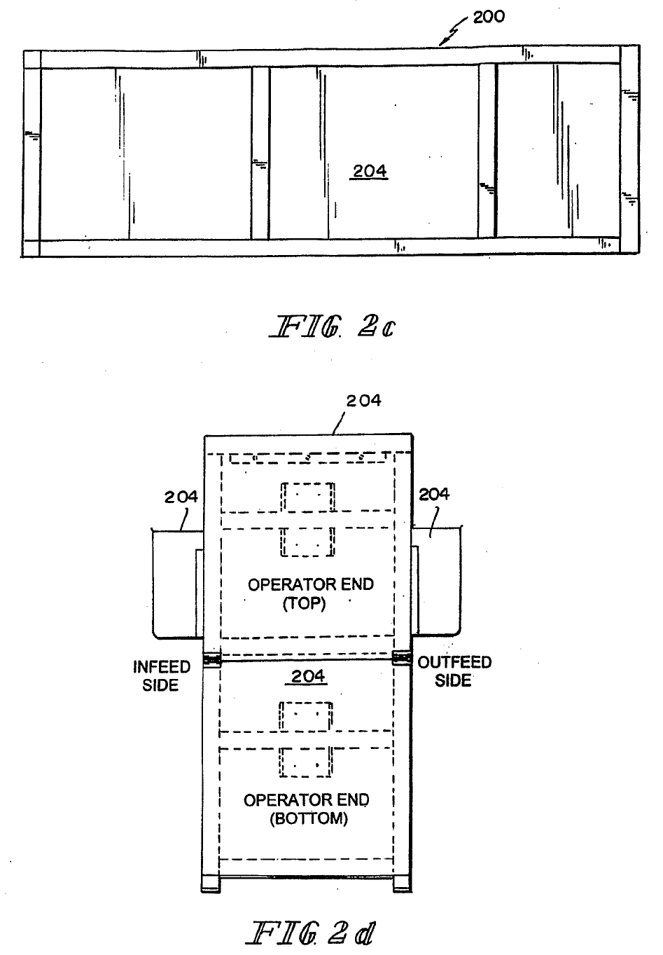

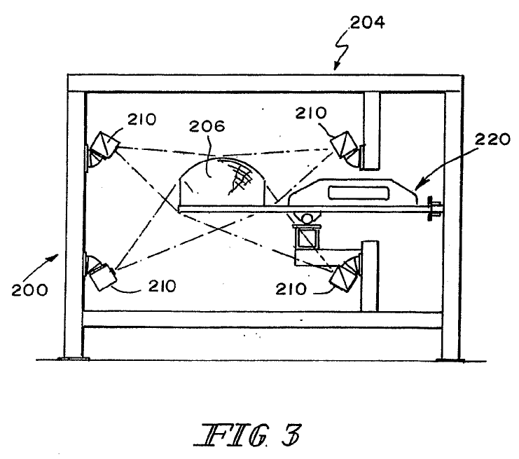

Referring first to FIGS. 1a-c, a top plan view of a system incorporating a flitch planer 202 according to the invention, a scanner section 200 includes an enclosure 204 (see also FIGS. 2a-d) through which a flitch 206 to be planed, or shaped, passes for scanning by a number, illustratively, four, of scanners 210, for example, model DiSCAN 100 optical scanners available from Microtec S. r. 1./GmbH, Brixen, Italy, as part of a DiSHAPE 100/4 3D shape scanner. See FIG. 3. The outputs of the scanners 210 are coupled by appropriate conductors (not shown) to a control system 212 including, for example, an appropriately programmed personal computer (hereinafter sometimes PC), the program of which calculates an optimum shaping strategy for the flitch 206 being scanned. A conveyor 220 extends through enclosure 204 and conveys the flitch 206 through the enclosure 204 past the scanners 210, where the flitch 206 is scanned and parameters obtained from the scanning are output to the control system 212. The control system 212 employs (an) algorithm(s) to calculate a solution for the shape into which the flitch 206 is planed in an effort to optimize the amount and quality of veneer which will subsequently be sliced from the thus-shaped flitch 206.

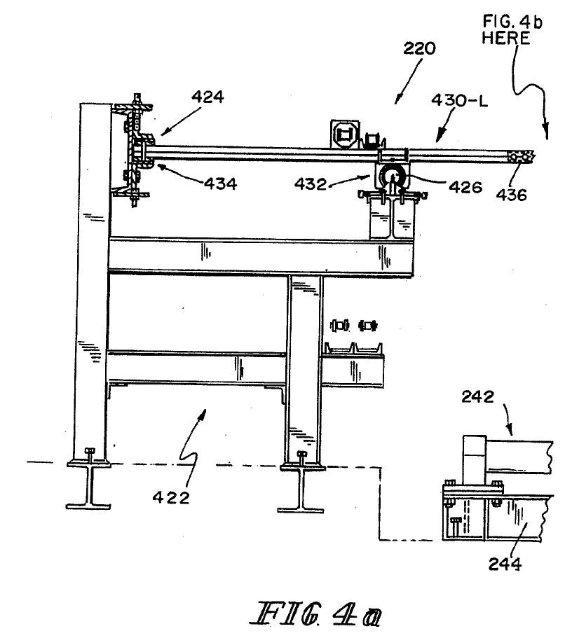

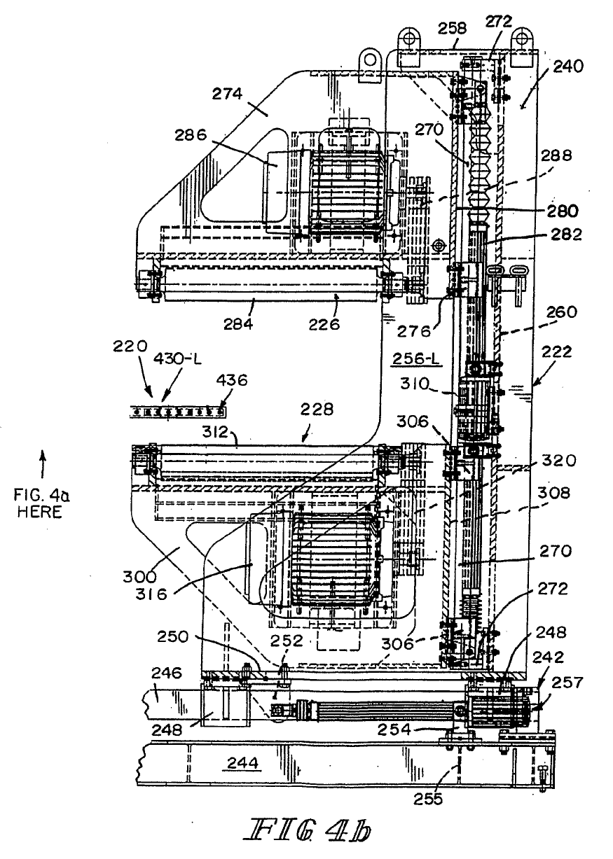

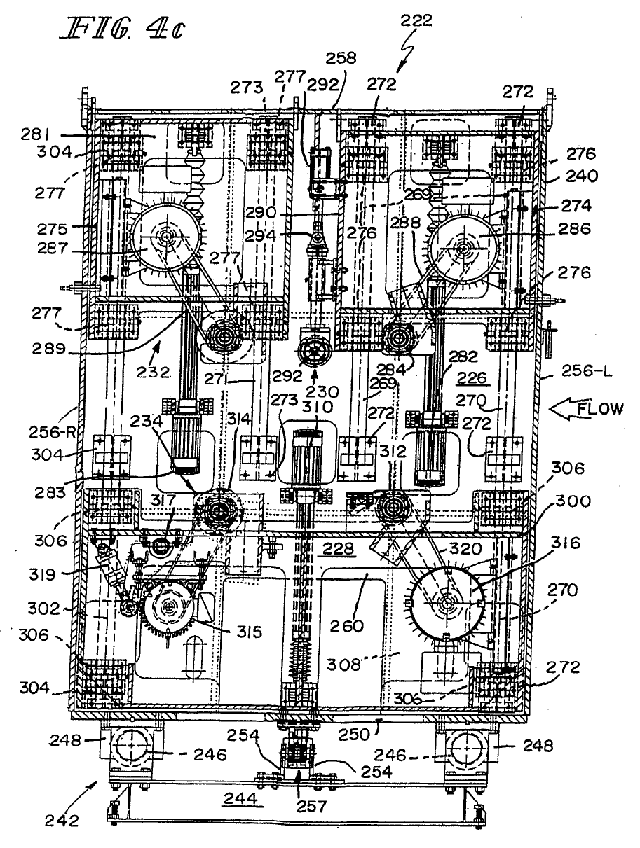

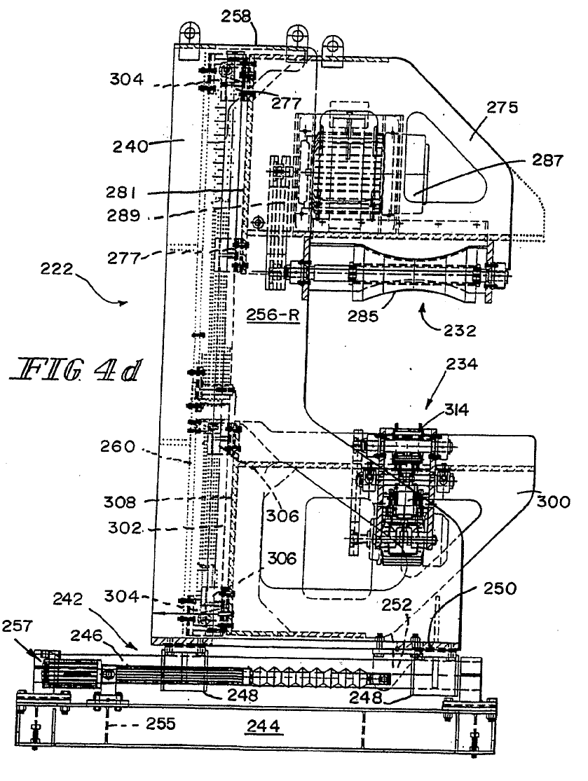

The flitch is then conveyed by conveyor 220 to a planing or shaping section 222 (see also FIGS. 4a-d) where the flitch 206 is planed in accordance with the solution provided by the control system 212. The planing section 222 is, of course, also coupled by appropriate conductors (not shown) to the control system 212 to receive inputs therefrom to enable the planing section 222 to shape the flitch 206 in such a way as to implement the solution. Referring specifically to FIGS. 4b-d, the planing section 222 includes an upper flat planer head assembly 226, a lower flat planer head assembly 228, a press roll assembly 230, an upper concave planer head assembly 232, and a groover assembly 234 for placing one or more grooves in the back side of the flitch, for example, for the purposes illustrated and described in U.S. Pat. Nos. 5,101,874 and 5,150,746.

The planing section 222 includes an outer frame assembly 240 and a slide base frame assembly 242 permitting movement of the outer frame assembly 240 transversely of the direction of motion of the flitch 206 on the conveyor 220 through planing or shaping section 222. Slide base frame assembly 242 comprises a rectangular I-beam base 244, a pair of cylindrical shafts 246 which extend in the directions of motion of the outer frame assembly 240, that is, transverse to the direction of motion of the flitch 206 through the planing section 222, and two pairs of linear bearings 248, each pair mounted on outer frame assembly 240 and slidable on one of the cylindrical shafts 246. The I-beam base 244 is constructed from, for example, 8″ width, 40 lb./ft. I-beam. Shafts 246 illustratively are 5-½″ diameter hard chromed steel shafts. The four linear bearings 248 are rectangularly arrayed on the underside of an outer frame bottom plate 250 of outer frame assembly 240. Outer frame bottom plate 250 illustratively is constructed from 1-½″ thick steel plate. A rod eye mount 252 is provided on the underside of outer frame bottom plate 250. Actuator trunnion mounts 254 are mounted on a cross member 255 of base 244. An actuator 257, such as, for example, a Moog model 884-027 inline EMA, is coupled between rod eye mount 252 and trunnion mounts 254 and is actuable to shift outer frame assembly 240 transversely of the direction of motion of flitch 206 through planing or shaping section 222.

Outer frame assembly 240 further includes outer frame left- and right-hand sides 256-L and 256-R, respectively, an outer frame top plate 258 and an outer frame back plate 260. Outer frame back plate 260 and side plates 256-L and 256-R illustratively are constructed from 1″ thick steel plate. Outer frame top plate 258 illustratively is constructed from ¾″ thick steel plate.

Referring particularly to FIGS. 4b-c, upper flat planer head assembly 226 is mounted to outer frame back plate 260 by a pair of vertically extending roundways 269, 270 which are mounted by roundway support blocks 272 to outer frame back plate 260. Upper flat planer head assembly 226 includes a weldment 274 to the rear corners of which are mounted two pairs of linear bearings 276, each pair slidable on one of roundways 269, 270. The four linear bearings 276 are rectangularly arrayed on the back side 280 of weldment 274. An actuator mounting assembly 282 is coupled between outer frame back plate 260 and back side 280 of weldment 274 to maintain a rotatably mounted generally right circular cylindrical cutterhead 284 in a desired vertical position to implement the planing solution. Actuator mounting assembly 282 may again be a Moog model 884-027 inline EMA. Cutterhead 284 is rotatably mounted in weldment 274 and is rotated by a motor 286, such as, for example, a Toshiba CT, 40 hp, 575 V, 60 Hz, 3600 rpm, 324 TS frame motor, through a drive belt 288. Press roll assembly 230 is mounted to an outer sidewall 290 of weldment 274 and includes a pneumatic press roll cylinder assembly 292 and a linear trunnion mount assembly 294 for maintaining a desired pressure on 20 the top surface of flitch 206 as flitch 206 passes under press roll assembly 230.

Lower flat planer head assembly 228 and groover assembly 234 are mounted in a lower support frame weldment 300. Lower support frame weldment 300 is mounted to outer frame back plate 260 by roundway 270 and a vertically extending roundway 302 which is mounted by roundway support blocks 304 to outer frame back plate 260. Lower support frame weldment 300 includes two pairs of linear bearings 306 rectangularly arrayed on the back side 308 of weldment 300. An actuator mounting assembly 310 is coupled between outer frame back plate 260 and back side 308 of weldment 300 to maintain a rotatably mounted generally right circular cylindrical cutterhead 312 and a groover head 314 in desired vertical positions. Actuator mounting assembly 310 may again be a Moog model 884-027 inline EMA. Cutterhead 312 is rotatably mounted in weldment 300 and is rotated by a motor 316, such as, for example, a Toshiba CT, 75 hp, 575 V, 60 Hz, 3600 rpm, 365 TS frame motor, through a drive belt 320. Groover head 314 and its drive motor 315 are pivotally mounted by a bearing and pillow block 317 from the underside of the top of weldment 300. A pneumatic cylinder 319 pivots groover head 314 upward into grooving orientation with respect to any flitch 206 which requires a groove(s) in its underside. When the groover head 314 is grooving a flitch 206, actuator 257 may also be actuated to move the groover head 314 transversely of the direction of motion of flitch 206 past groover head 314. This results in the groove(s) being cut by groover head 314 extending at a desired angle to the longitudinal extent of the flitch 206 being grooved, so that when the flitch 206 is mounted to equipment for converting it into veneer, it is canted at an angle to horizontal, facilitating slicing of veneer from the flitch 206.

Referring particularly to FIGS. 4c-d, upper concave planer head assembly 232 is mounted to outer frame back plate 260 by vertically extending roundway 302 and a vertically extending roundway 271 which is mounted by roundway support blocks 273 to outer frame back plate 260. Upper concave planer head assembly 232 includes a weldment 275 to the rear corners of which are mounted two pairs of linear bearings 277, each pair slidable on a respective one of roundways 271, 302. The four linear bearings 277 are rectangularly arrayed on the back side 281 of weldment 275. An actuator mounting assembly 283 is coupled between outer frame back plate 260 and back side 281 of weldment 275 to maintain a rotatably mounted generally concave circular cylindrical cutterhead 285 in a desired vertical position to implement the planing solution. Concave planer head assembly 232 is particularly useful in situations where flitches 206 are being prepared for mounting on staylogs to be cut during rotation of the staylogs. Actuator mounting assembly 283 may again be a Moog model 884-027 inline EMA. Cutterhead 285 is rotatably mounted in weldment 275 and is rotated by a motor 287, such as, for example, a Toshiba CT, 40 hp, 575 V, 60 Hz, 3600 rpm, 324 TS frame motor, through a drive belt 289.

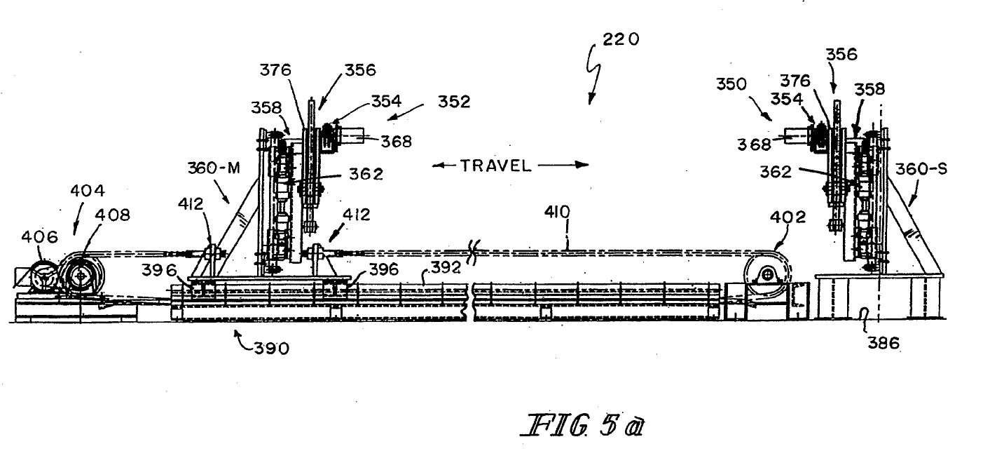

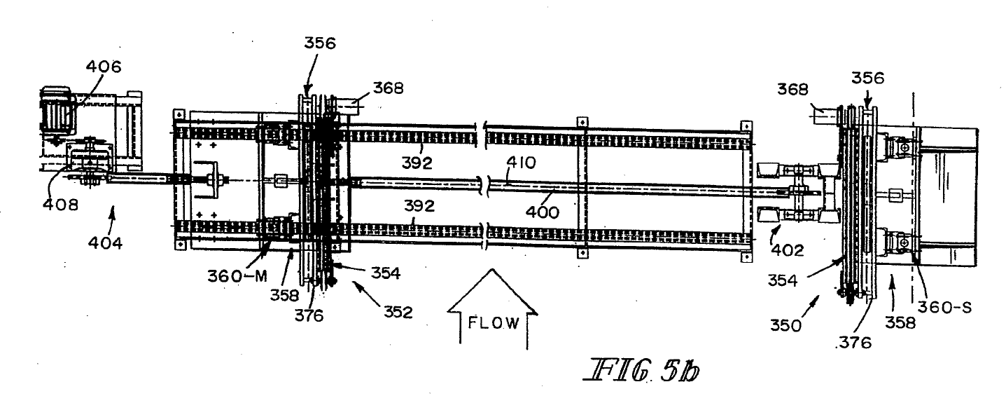

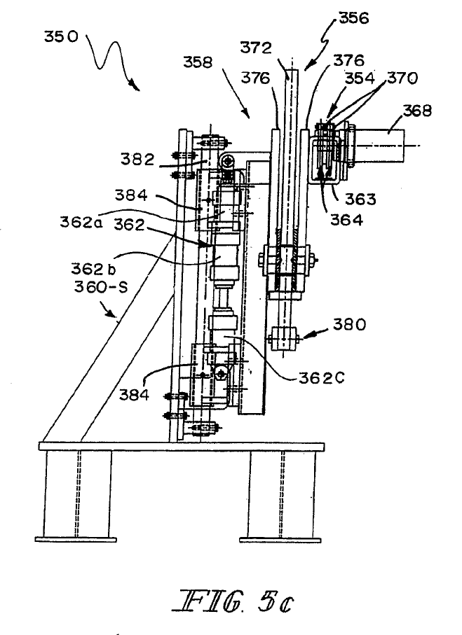

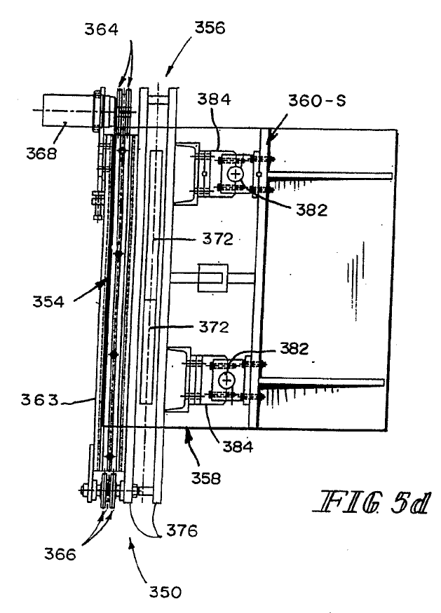

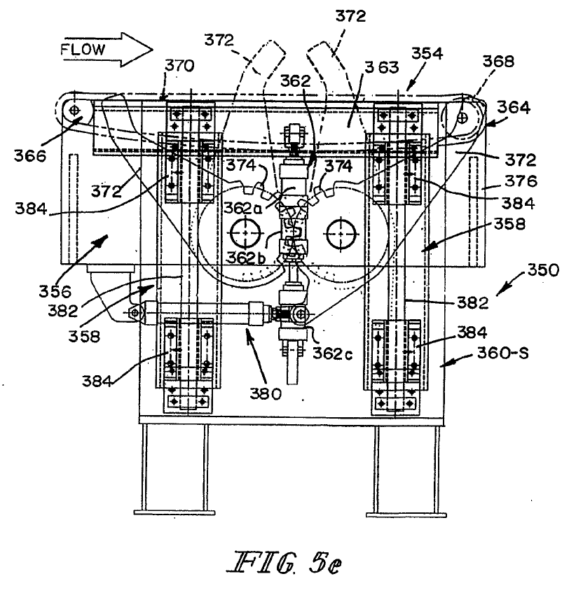

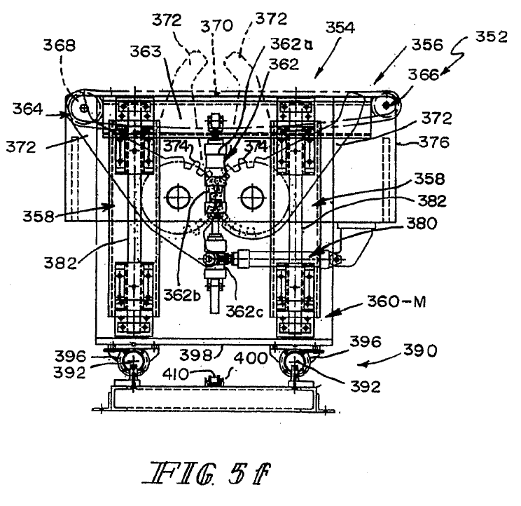

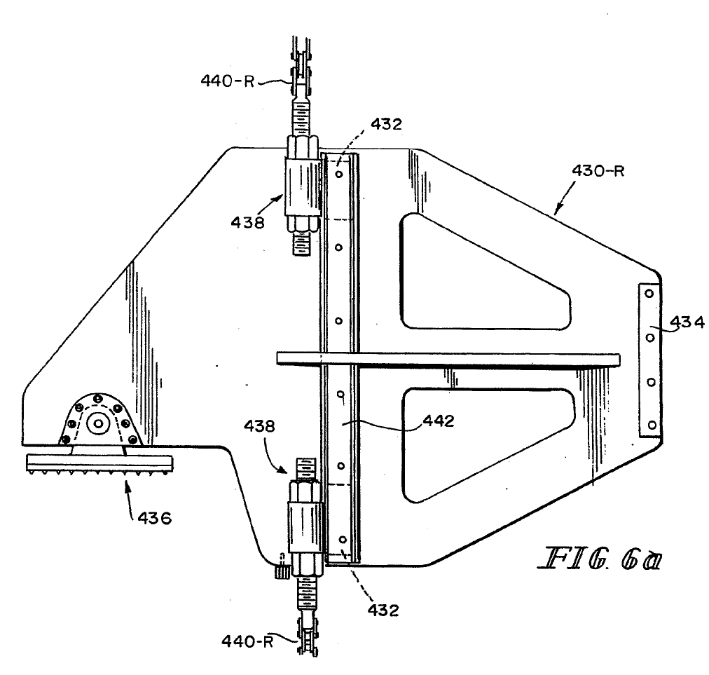

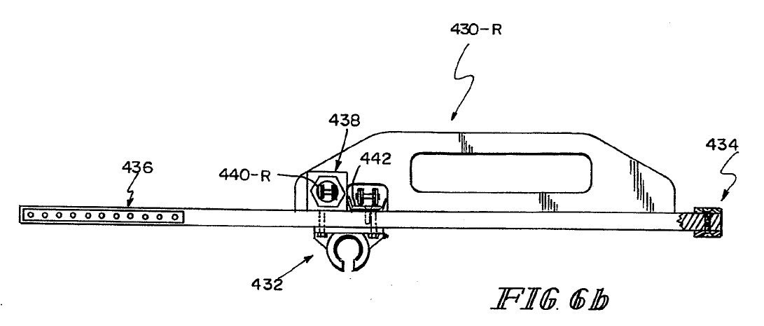

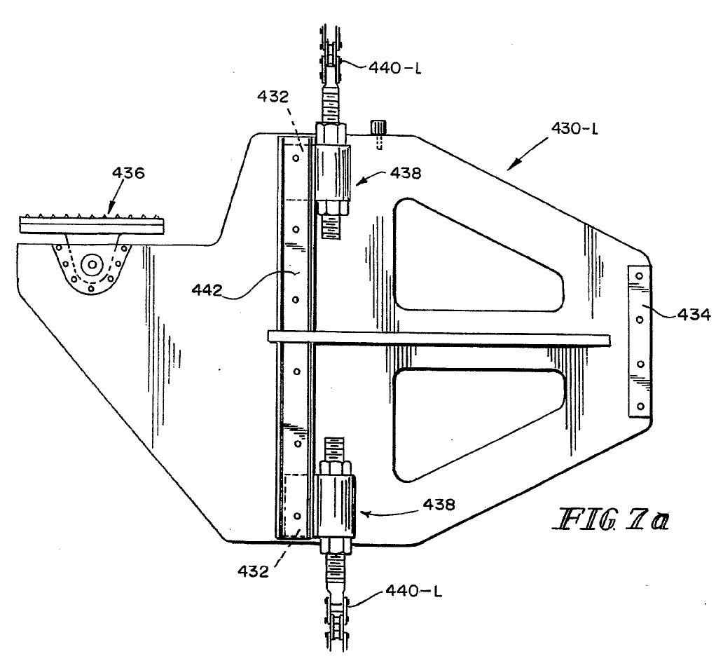

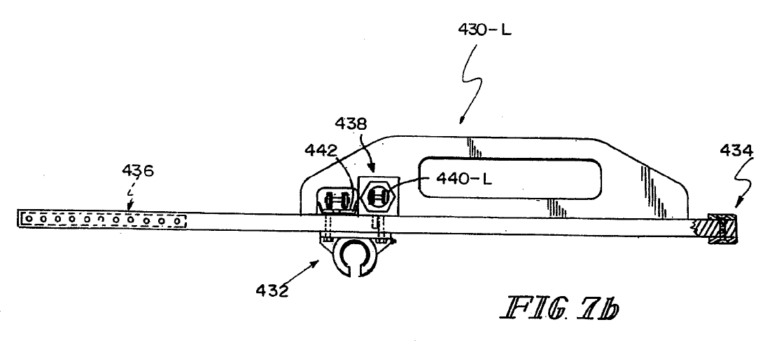

Referring now specifically to FIGS. 1a and 5a-f, conveyor 220 includes a stationary centering arm and chain runner assembly 350 and a movable centering arm and chain runner assembly 352. Each of stationary centering arm and chain runner assembly 350 and movable centering arm and chain runner assembly 352 includes a chain runner assembly 354 for conveying the flitch 206 toward the transverse center of the assembly 350, a centering arm assembly 356 for positioning one of the ends of flitch 206, slide assemblies 358, a slide frame 360 for supporting slide assemblies 358, and a lift cylinder assembly 362. As best illustrated in FIGS. 5c, e and f, each lift cylinder assembly 362 comprises three hydraulic cylinders 362a-c, permitting its respective chain runner assembly 354 to be lifted to a selected one of three different heights by actuation of (a) selected one(s), or all, of the three hydraulic cylinders 362a-c, depending upon the amount of wood which is to be removed from the fitch 206, and whether wood is to be removed from the top side of the flitch 206, the bottom side of the flitch 206, or both.

Referring now particularly to FIGS. 5c-f, each chain runner assembly 354 includes a rectangular cross section tubular chain race 363 supporting a drive sprocket 364 at one end and a driven sprocket 366 at the other end. The drive sprocket 364 is driven by a chain drive 368 which illustratively is a Char-Lynn 2000 series wheel motor, 29.8 c. i. d., model 105-1148. A chain 370 is trained about the sprockets 364, 366. The upper bight of the chain 370 extends across the outside of the top wall of the race 363. The lower bight of the chain 370 extends through the interior of the race 363.

Centering arm assembly 356 includes a pair of centering arms 372 with meshing gear teeth 374 to synchronize their motion, and a frame 376 for pivotally supporting the centering arms 372 with their gear teeth 374 in engagement. Centering arm assembly 356 also includes a motor 380, such as a Hydro-Line 2″ bore by 10″ stroke hydraulic cylinder for moving centering arms 372 between their flitch 206-centering and -releasing orientations.

Slide assemblies 358 each include a shaft 382, such as a 2″ diameter hard chromed steel shaft, mounted vertically to slide frame 360. A pair of linear bearings 384 is slidably mounted on each shaft 382. The linear bearings 384 are mounted to frame 376, permitting centering arm assembly 356 to reciprocate 25 vertically with respect to slide frame 360.

Lift cylinder assembly 362 is coupled between slide frame 360 and frame 376. Actuation of lift cylinder assembly 362 reciprocates frame 376, and chain runner assembly 354 and centering arm assembly 356 which are mounted to frame 376, vertically with respect to slide frame 360.

The slide frame 360-S of stationary centering arm and chain runner assembly 350 is stationarily mounted, for example, on a veneer mill floor 386. Referring specifically to FIGS. 5a, b and f, the slide frame 360-M of movable centering arm and chain runner assembly 352 is mounted on a slide base assembly 390 for movement toward and away from stationary centering arm and chain runner assembly 350 to accommodate flitches 206 of different lengths. Slide base assembly 390 includes a pair of laterally spaced, longitudinally extending roundways 392, such as, for example, 3″ diameter hard chromed steel shafts mounted on rails of the slide base 390. Two pairs of slotted linear bearings 396 are mounted on the underside 398 of slide frame 360-M. The laterally spaced pairs of slotted linear bearings 396 slidably engage respective roundways 392 to permit movement of slide frame 360-M along slide base assembly 390. A chain runner assembly 400 extends lengthwise of slide base assembly 390 between roundways 392. Chain runner assembly 400 includes an idler assembly 402 mounted at one end of slide base 390, illustratively, the end thereof adjacent stationary centering arm and chain runner assembly 350. Chain runner assembly 400 also includes a drive assembly 404 mounted at the other end of slide base 390. Drive assembly 404 includes a drive motor 406 and transmission 408, illustratively a 5 h.p. vector motor and Cyclo model CHHM 6155YA51 reducer. This combination is capable of moving movable centering arm and chain runner assembly 352 at about 60 ft./min. toward and away from stationary centering arm and chain runner assembly 350. A chain 410 is trained about idler and drive sprockets of assemblies 402 and 404, and the ends of chain 410 are coupled to chain takeup assemblies 412 provided on slide frame assembly 360-M.

Referring now specifically to FIGS. 1a-c, 4a-b, 6a-b and 7a-b, conveyor 220 further includes a flitch transport conveyor 420. Flitch transport conveyor 420 includes a conveyor frame 422 fabricated from, for example, 6″ wide, 20 lb./ft. I-beam. Frame 422 illustratively extends about 88′, a considerable portion of the length of the planer 202. Frame 422 includes an end dogger slide back channel 424, and end roundway 426 which illustratively is constructed from 3″ diameter 4140/42 stock, mounted on a rail. Flitch transport conveyor 420 further includes a pair of dogger arm assemblies 430, one, 430-L, for engaging the downstream end of the flitch 206, and one, 430-R, for engaging the upstream end of the flitch 206. It is here noted that dogger arm assemblies 430-L and 430-R are illustrated in two different orientations in FIGS. 1a-c, but this is done for purposes of explanation only.

Each dogger arm assembly 430 includes a pair of slotted linear bearings 432 on the underside thereof adjacent opposite sides of the dogger arm assembly 430 for engaging roundway 426, an end slide bar 434 at the rear end of the dogger arm assembly for engaging the end dogger slide back channel 424, and a pivotally mounted spike plate 436 at the forward end of the dogger arm assembly for engaging an end of the flitch 206. Each dogger arm assembly 430 also includes chain talceup assemblies 438 adjacent opposite sides of the dogger arm assembly 430. The chain takeup assemblies 438 on dogger arm assembly 430-L are offset lengthwise of the dogger arm assembly (widthwise of the flitch transport conveyor 420) from the chain takeup assemblies 438 on dogger aim assembly 430-R, and each dogger arm assembly 430-R, 430-L is shuttled along the length of flitch transport conveyor 420 by a separate drive chain 440-R, 440-L, respectively. This permits the dogger arm assemblies 430-R, 430-L to be separately brought into engagement with the respective opposite ends of flitch 206 without regard to the length of the flitch 206. The two chains 440-R, 440-L run side by side, and a chain runner bar 442 is provided on the top side of each dogger arm assembly 430-R, 430-L to accommodate the drive chain 440-L, 440-R of the other dogger arm assembly 430-L, 430-R, respectively. Drive chains 440-L, 440-R are trained about idler sprockets 444-L, 444-R, respectively, at the upstream end of flitch transport conveyor 420, and about drive sprockets 446-L, 446-R, respectively, at the downstream end of flitch transport conveyor 420. Drive sprockets 446-L, 446-R are coupled through suitable transmissions to the output shafts of flitch transport conveyor 420 drive motors 448-L, 448-R, respectively. Drive motors 448 illustratively are 60 h. p. 575 V, vector drive, 60 Hz, 3600 r. p. m. 364 TC frame motors.

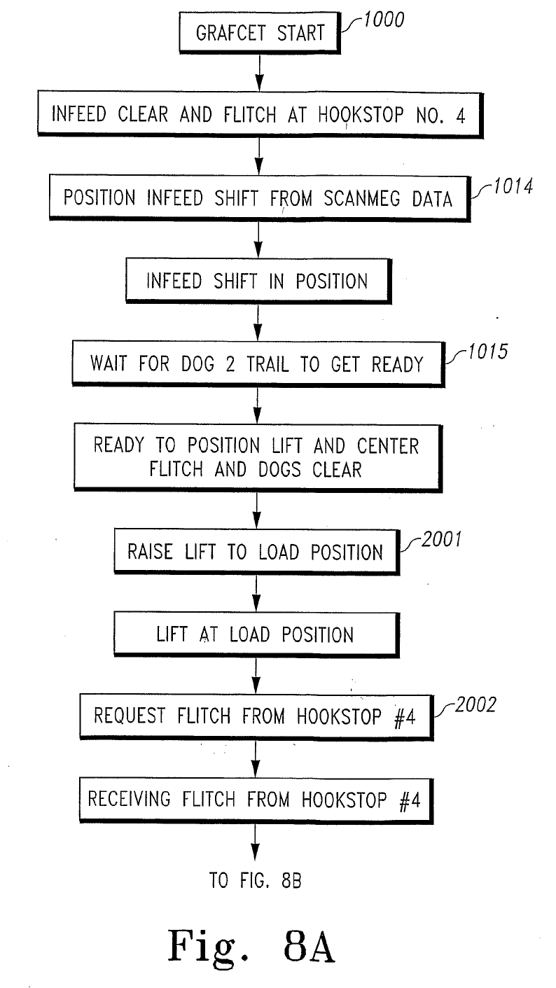

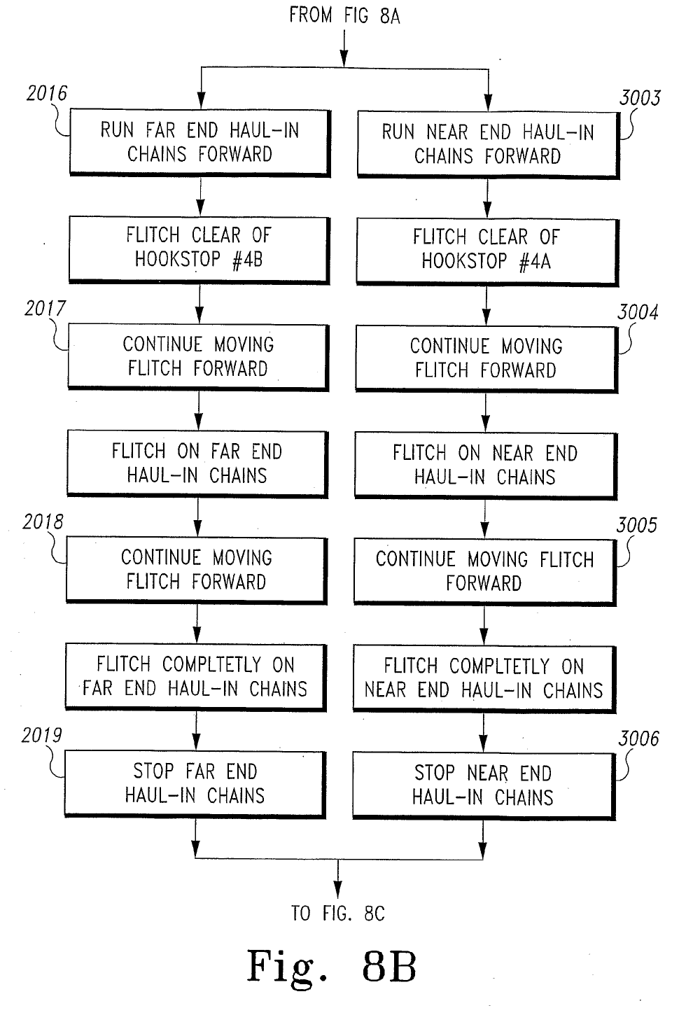

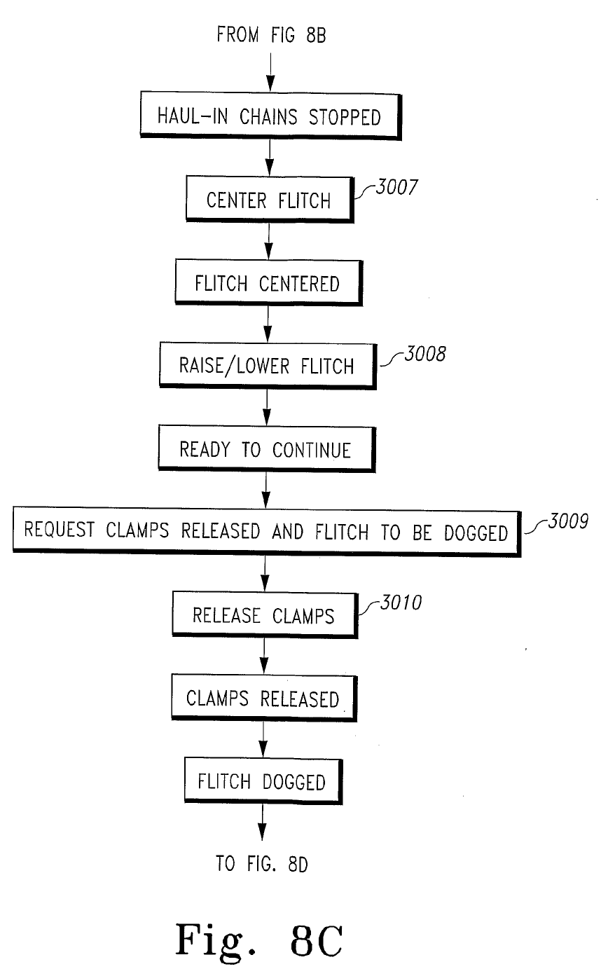

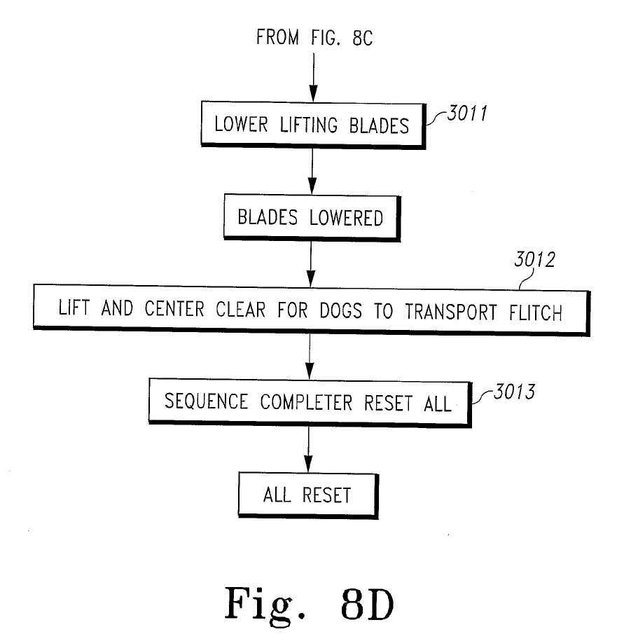

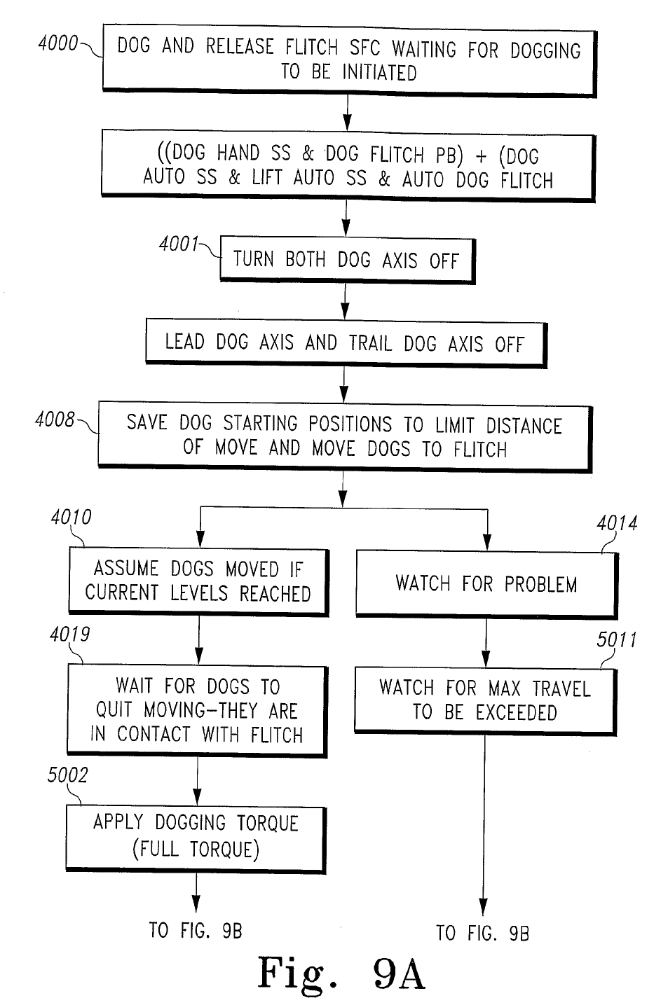

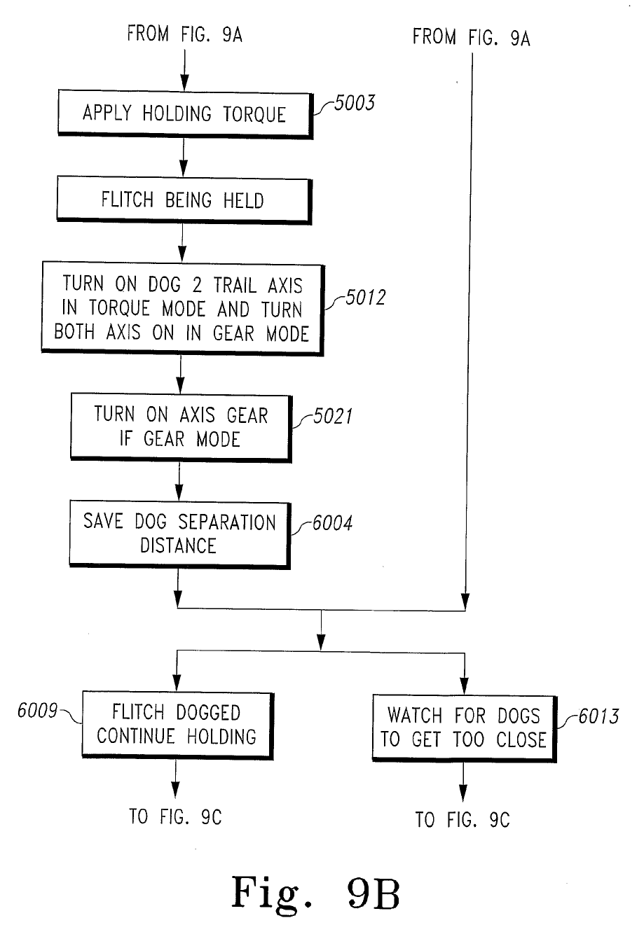

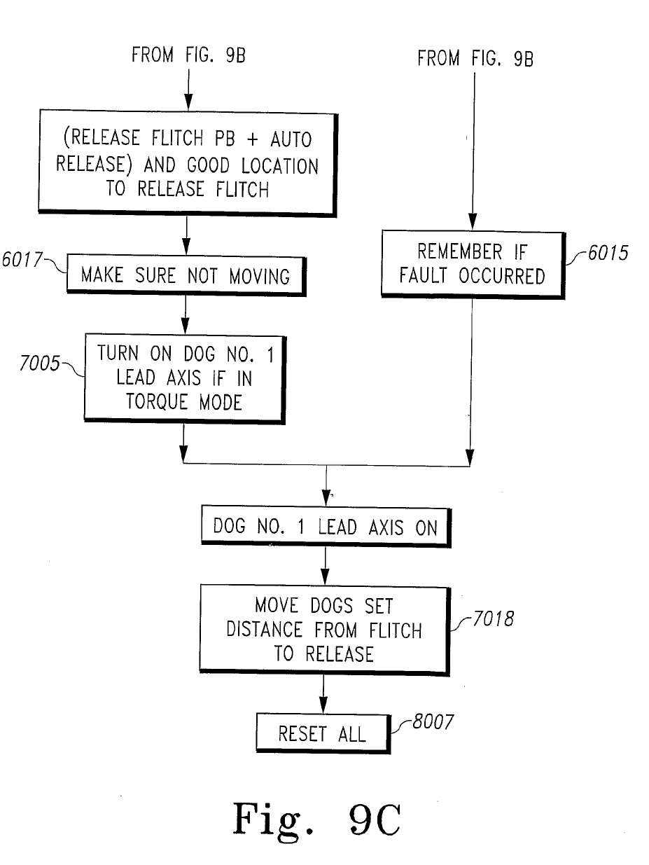

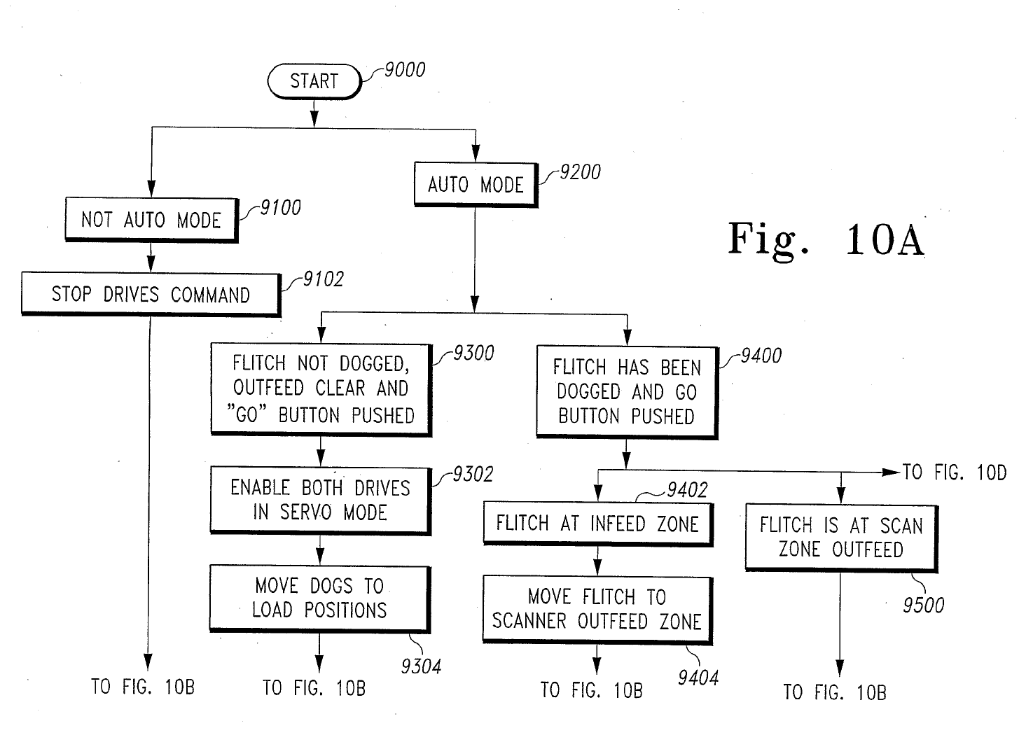

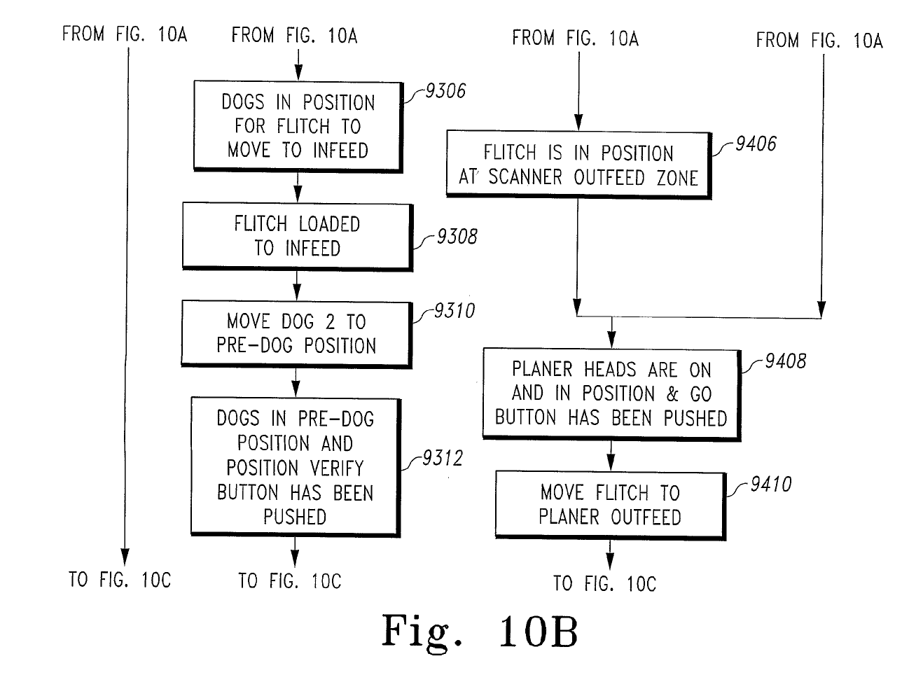

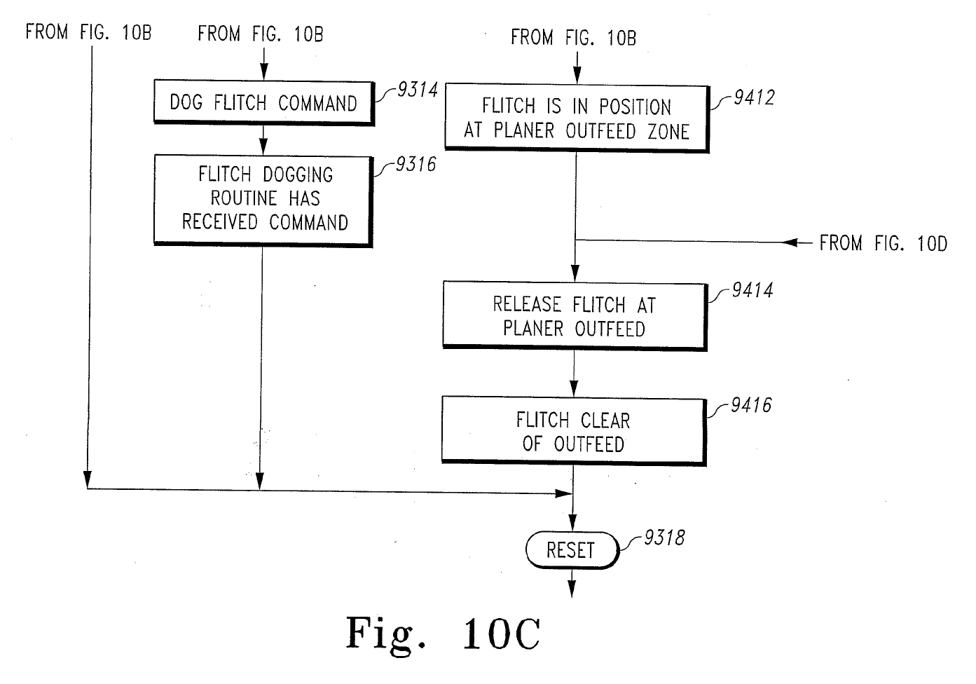

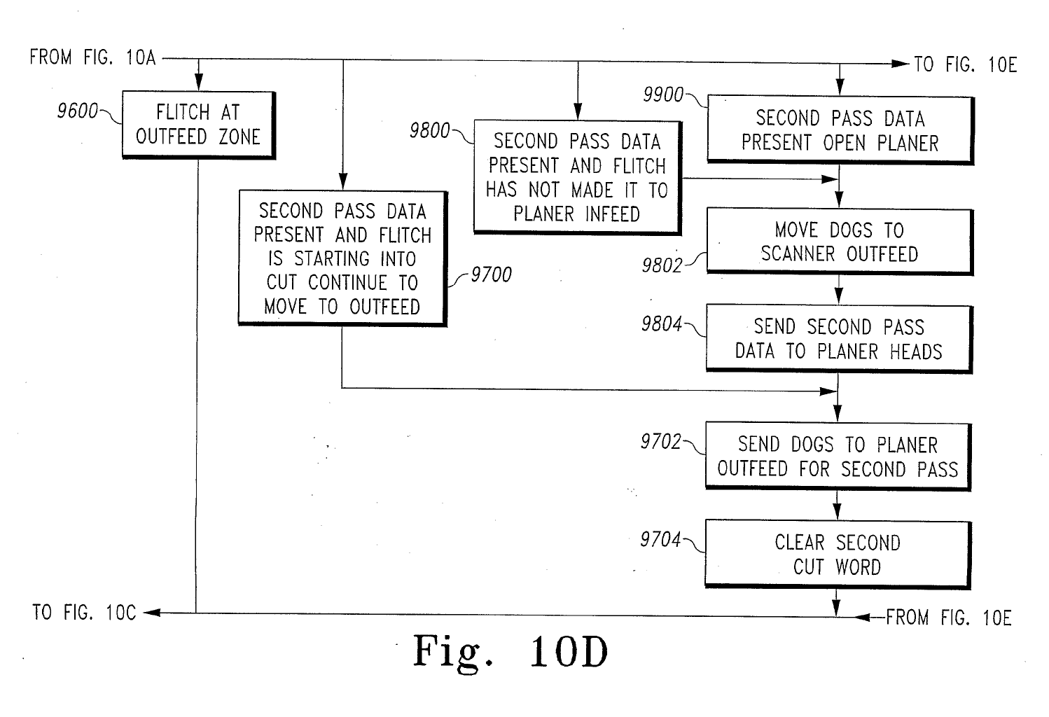

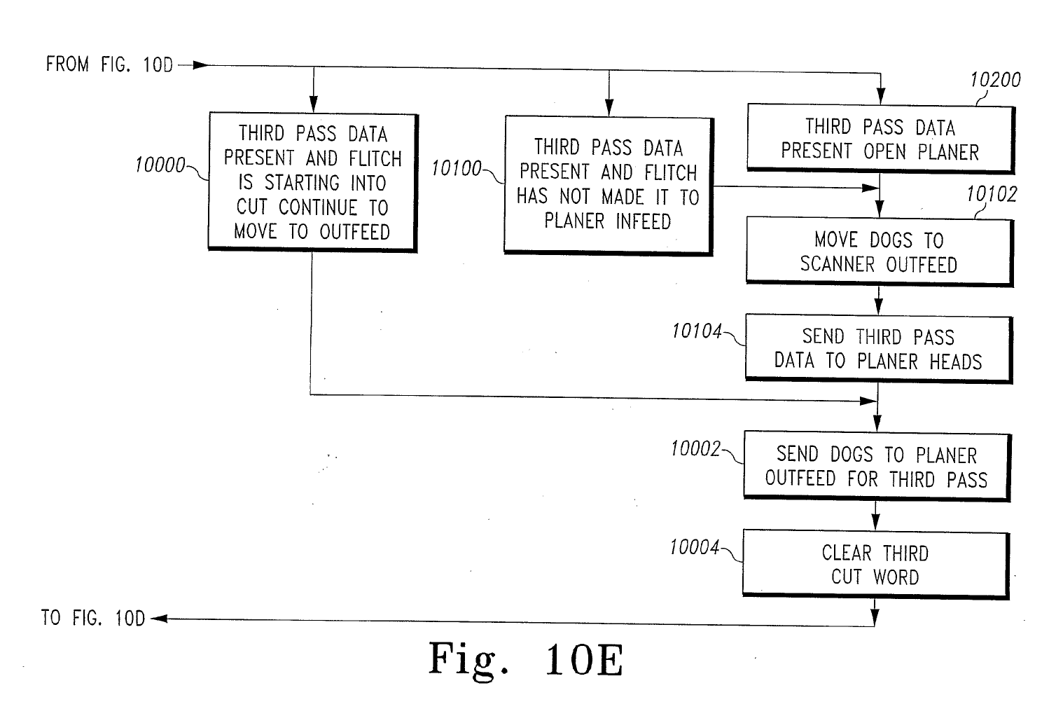

Turning now to FIGS. 8a-d, an infeed routine is initialized in a step 1000. At this time, the infeed is clear and the flitch 206 is resting against a set of pivotally deployable stops 462 near the top of entry end conveyor 460. A scanner 458 arrayed across entry end conveyor 460 provides data related to the length of the flitch 206, and the control system 212 uses this data to position the movable centering arm and chain runner assembly 352 for infeed of the flitch 206 in a step 1014. After this step, the movable centering arm and chain runner assembly 352 is in position. The control system 212 then waits for the return of the dogs 430 to the upstream end of the conveyor 220 in a step 1015. At this time, the stationary centering arm and chain runner assembly 350 and the movable centering arm and chain runner assembly 352 are ready to position, lift and center the flitch 206. The stationary centering arm and chain runner assembly 350 and the movable centering arm and chain runner assembly 352 are in position to center the flitch 206 and raise the flitch 206 into position to be dogged by dogs 430 in a step 2001. The control system 212 requests the flitch 206 from the top of entry end conveyor 460 in a step 2002. At this time, the stationary centering arm and chain runner assembly 350 and the movable centering arm and chain runner assembly 352 receive flitch 206 from the top of entry end conveyor 460.

The chains 370 of stationary centering arm and chain runner assembly 350 and the movable centering arm and chain runner assembly 352 are run to center the flitch 206 on the stationary centering arm and chain runner assembly 350 and the movable centering arm and chain runner assembly 352 in a step 2016 and a step 3003, FIG. 8b. At this time, the flitch 206 is clear of the top of entry end conveyor 460. The flitch 206 continues to move forward in a step 2017, FIG. 8c, and a step 3004. At this time, the flitch 206 is on the entry ends of the chains 370. The chains 370 continue moving flitch 206 forward in a step 2018 and a step 3005. The chains 370 are stopped in a step 2019 and a step 3006.

The centering arms 372 are actuated to center flitch 206 in a step 3007, FIG. 8c. The hydraulic cylinders 362a-c are actuated to raise or lower flitch 206 as necessary in a step 3008. The control system 212 then requests the centering arms 372 to release the flitch 206 and flitch 206 to be dogged in a step 3009. The centering arms 372 release flitch 206 in a step 3010. The centering arms 372 are lowered in a step 3011, FIG. 8d. The dogs 430 are then clear to transport flitch 206 in a step 3012. The infeed lift and center routine completed, the routine is reset in a step 3013.

Turning now to FIGS. 9a-d, a dog and release flitch routine waits for dogging to be initiated in step 4000. Both dog 430-R, 430-L axes (each dog 430 is an independent axis of motion having its own motion controller and motor 448) are turned off in a step 4001. Dog 430-R, 430-L starting positions are saved in order to limit the distance through which the dogs 430-R, 430-L have to be moved to engage a flitch 206 in a step 4008. In a step 4010, the routine assumes the dogs 430-R, 430-L are moved if current dog 430-R, 430-L positions are reached. The routine waits for the dogs 430-R, 430-L to stop moving and assumes that the dogs 430-R, 430-L are in contact with the flitch 206 in a step 4019. Full dogging torque is applied by the dog drive motors 448-L, 448-R in a step 5002.

Holding torque is applied by the dog drive motors 448-L, 448-R in a step 5003, FIG. 9b. Two different methods were explored for holding the flitch 206. In a so-called “torque mode,” a constant torque was applied by one of the dog drive motors 448-L, 448-R and position controlled the other. In a so-called “gear mode,” the two dog drive motors 448-L, 448-R were electronically geared together as a master and a slave. It was determined that the gear mode worked more reliably to hold the flitch 206, as a result of which the gear mode was implemented in the control system 212 in its current state. One dog 430-R, 430-L drive motor 448-L, 448-R is turned on in torque mode and both motor 448-L, 448-R axes are turned on in gear mode in a step 5012. The drive motors 448-L, 448-R are turned on if the dogs 430-R, 430-L are in gear mode in a step 5021. The dog 430-R, 430-L separation distance is saved in a step 6004. Simultaneously with steps 4010-6004, the routine watches for problems in the dogging operation in a step 4014, FIG. 9a, and watches for maximum dog 430-R, 430-L travel to be exceeded in a step 5011.

The flitch 206 is dogged and holding is continued in a step 6009, FIG. 9b. The routine checks to be sure the dogs 430-R, 430-L are not moving with respect to each other in a step 6017, FIG. 9c. One of the dog 430-R, 430-L drive motors 448-L, 448-R is turned on if the dogs 430-R, 430-L are in torque mode in a step 7005. Simultaneously with steps 6009-7005, the routine watches for the dogs 430-R, 430-L to get too close in a step 6013, FIG. 9b, and remembers if a fault occurred in a step 6015, FIG. 9c. The dogs 430-R, 430-L are moved a set distance from the flitch 206 to release the flitch in a step 7018. The routine is reset in a step 8007.

Turning now to FIGS. 10a-e, a routine for planing flitches 206 begins with initialization of the routine, step 9000, FIG. 10a. If the routine is not in the AUTO mode, step 9100, the routine issues a STOP DRIVES 448-L, 448-R command, step 9102, the routine is reset, step 9318, FIG. 10c, and returns to the initialization step 9000, FIG. 10a.

If the routine is in the AUTO mode, step 9200, no flitch 206 is dogged, the conveyor 420 outfeed is clear and the GO switch on control system 212 is activated, step 9300, both dog drives 448-L, 448-R are enabled in servo mode, step 9302. The dogs 430-R, 430-L are moved to LOAD positions, step 9304. The dogs 430-R, 430-L are then in position for a flitch 206 to move to the conveyor 420 infeed, step 9306, FIG. 10b. A flitch 206 is loaded on the conveyor 420 infeed, step 9308. The dogs 430-R, 430-L are moved to pre-dogging positions, step 9310. The dogs 430-R, 430-L are in the pre-dogging positions and the POSITION VERIFY switch on control system 212 has been activated, step 9312. The DOG FLITCH 206 command is then issued, step 9314, FIG. 10c, and the routine receives the DOG FLITCH 206 command, step 9316. The routine is reset, step 9318, and returns to the initialization step 9000, FIG. 10a.

If the routine is in the AUTO mode, step 9200, a flitch 206 has been dogged and the GO switch on control system 212 is activated, step 9400, FIG. 10a, and a flitch 206 is at the conveyor 420 infeed zone, step 9402, the flitch 206 is moved to the scanner 200 outfeed zone, step 9404, being scanned for a planing solution as it proceeds to the scanner 200 outfeed zone. If the flitch 206 is in position at the scanner 200 outfeed zone, step 9406, the routine determines if the planer heads 226, 228, 230, 232, 234 are on and in position and the GO switch on control system 212 is activated, step 9408. The flitch 206 is moved to the planer 222 outfeed, being planed as it proceeds through the planer 222, step 9410. Once the flitch 206 is in position at the planer 222 outfeed, step 9412, FIG. 10c, the flitch 206 is released at the planer 222 outfeed, step 9414. The routine waits until the flitch 206 is clear of the planer 222 outfeed, step 9416, and is reset, step 9318 and returns to the initialization step 9000, FIG. 10a.

As an alternative to steps 9402, 9404 and 9406, the flitch 206 may already be at the scanner 200 outfeed zone, step 9500, FIG. 10a. In this case, the routine proceeds through steps 9408, 9410, 9412, 9414, 9416 and 9318, FIGS. 10b-c, as described above.

As an alternative to steps 9402, 9404, 9406, 9408, 9410 and 9412 or 9500, 9408, 9410 and 9412, in step 9600, FIG. 10d, the flitch 206 is at the outfeed zone. The routine then proceeds through steps 9414, 9416 and 9318, FIG. 10c, as described above.

As another alternative to steps 9402, 9404, 9406, 9408, 9410 and 9412 or 9500, 9408, 9410 and 9412, in step 9700, FIG. 10d, second pass (through the planer 222) data is present and the fitch 206 is beginning a second pass through the planer 222. The flitch 206 is moved to the outfeed. The dogs 430-R, 430-L are moved to the planer 222 outfeed, step 9702. A second planer 222 pass software word in the routine is cleared, step 9704. The routine then proceeds through steps 9414, 9416 and 9318, FIG. 10c, as described above.

As an alternative to step 9700, FIG. 10d, second pass data is present and the flitch 206 is not yet at the planer 222 infeed, step 9800. The dogs 430-R, 430-L are moved to the scanner 200 outfeed, step 9802, and the second pass data is sent to the planer heads 226, 228, 230, 232, 234, step 9804. The routine then proceeds through steps 9702, 9704, 9414, 9416 and 9318, FIGS. 10d and c, as described above.

As an alternative to step 9800, FIG. 10d, second pass data is present and the planer 222 is open, step 9900. The routine then proceeds through steps 9802, 9804, 9702, 9704, 9414, 9416 and 9318, FIGS. 10d and c, as described above.

As another alternative to steps 9402, 9404, 9406, 9408, 9410 and 9412, in a step 10000, FIG. 10e, third pass (through the planer 222) data is present and the flitch 206 is beginning a third pass through the planer 222. The dogs are sent to the planer 222 outfeed for the third pass, step 10002. A third planer 222 pass software word in the routine is cleared, step 10004. The routine then proceeds through steps 9414, 9416 and 9318, FIG. 10c, as described above.

As an alternative to step 10000, third pass data is present and the flitch 206 has not yet reached the planer 222 infeed, step 10100, FIG. 10e. The dogs are moved to the scanner 200 outfeed, step 10102. The third pass data is then sent to the planer heads 226, 228, 230, 232, 234, step 10104. The routine then proceeds through steps 10002, 10004, 9414, 9416 and 9318, FIGS. 10e and c, as described above.

As an alternative to step 10100, third pass data is present and the planer 222 is opened (that is, all of heads 226, 228, 230, 232, 234 are withdrawn), step 10200, FIG. 10e. The routine then proceeds through steps 10102, 10104, 10002, 10004, 9414, 9416 and 9318, FIGS. 10e and c, as described above.

What is claimed:

1. Apparatus for shaping a flitch, the apparatus including a first shaping head assembly for shaping a first surface of the flitch, a second shaping head assembly for shaping a second surface of the flitch, and a groover assembly for placing at least one groove in a surface of the flitch.

2. The apparatus of claim 1 further including a control system for providing a shaping solution and controlling the apparatus in accordance with the shaping solution to shape the flitch.

3. The apparatus of claim 1 further including a first frame assembly for supporting the first shaping head assembly, the second shaping head assembly, and the groover assembly, and a second frame assembly, the first and second frame assemblies together comprising at least one slideway which extends in the directions of motion of the first frame assembly, and at least one bearing engaging the at least one slideway.

4. The apparatus of claim 3 wherein the at least one bearing is provided on the first frame assembly.

5. The apparatus of claim 3 further comprising a motor coupled between the second frame assembly and the first frame assembly and actuable to shift the first frame assembly transversely of the direction of motion of the flitch through the apparatus.

6. The apparatus of claim 1 wherein the first shaping head assembly is mounted to the first frame assembly by at least one slideway, at least one bearing slidable on the at least one slideway, and an actuator mounting assembly coupled between the first frame assembly and the first shaping head assembly to maintain the first shaping head assembly in a desired position to shape the flitch.

7. The apparatus of claim 6 further including a press roll assembly mounted to the first shaping head assembly and a motor for maintaining a desired pressure on the flitch as the flitch passes the press roll assembly.

8. The apparatus of claim 1 wherein the second shaping head assembly is mounted to the first frame assembly by at least one slideway, at least one bearing slidable on the at least one slideway, and an actuator mounting assembly coupled between the first frame assembly and the second shaping head assembly to maintain the second shaping head assembly in a desired position for shaping the flitch.

9. The apparatus of claim 1 wherein the groover assembly is mounted to the first frame assembly by at least one slideway, at least one bearing slidable on the at least one slideway, and an actuator mounting assembly coupled between the first frame assembly and the groover assembly to maintain the groover assembly in a desired position for placing at least one groove in a surface of the flitch.

10. The apparatus of claim 9 further comprising a motor to control the first frame assembly and the groover assembly so that when the groover assembly is grooving a flitch, the first frame assembly moves transversely of the direction of motion of the flitch past the groover assembly.

11. The apparatus of claim 1 wherein the first shaping head assembly is mounted to the first frame assembly by at least one slideway and at least one bearing and an actuator mounting assembly is coupled between the first frame assembly and the first shaping head assembly to maintain the first shaping head assembly in a desired position to shape the flitch.

12. An apparatus for conveying a flitch including at least one centering arm and chain runner assembly, the at least one centering arm and chain runner assembly including a chain runner assembly for conveying the flitch toward a transverse center of the centering arm and chain runner assembly, and a centering arm assembly for positioning the flitch.

13. The apparatus of claim 12 further including at least one slide assembly, a slide frame for supporting the slide assembly, and a motor assembly for positioning at least a portion of the centering arm and chain runner assembly with respect to at least another portion of the centering arm and chain runner assembly.

14. The apparatus of claim 13 including first and second centering arm and chain runner assemblies, each including a chain runner assembly for conveying the flitch toward a transverse center of the centering arm and chain runner assembly, a centering arm assembly for positioning the flitch, a slide assembly, a slide frame for supporting the slide assembly, and a lift motor assembly.

15. The apparatus of claim 14 wherein a first one of the slide frames is mounted on a slide base assembly for movement toward and away from a second one of the slide frames.

16. The apparatus of claim 15 wherein the first one of the slide frames is mounted on a slide base assembly.

17. The apparatus of claim 16 wherein one of the first slide frame and the slide base includes at least one slideway and the other of the first slide frame and the slide base includes at least one bearing for engaging the slideway for movably mounting the first slide frame on the slide base.

18. The apparatus of claim 16 further including a chain runner assembly for moving the first one of the slide frames toward and away from the second one of the slide frames, the chain runner assembly including an idler assembly mounted beyond a first limit of movement of the slide base and a drive assembly mounted beyond a second limit of movement of the slide base.

19. The apparatus of claim 13 wherein the motor assembly comprises a plurality of fluid cylinders, actuation of a selected one or selected ones of the plurality of fluid cylinders permitting at least a portion of the centering arm and chain runner assembly to be moved with respect to at least another portion of the centering arm and chain runner assembly a selected distance of multiple different distances.

20. The apparatus of claim 12 further including at least one slide assembly, a slide frame for supporting the slide assembly, a slideway mounted to one of the slide assembly and slide frame, and at least one bearing mounted to the other of the slide assembly and slide frame to permit relative movement between the slide assembly and slide frame.

21. The apparatus of claim 20 further including a motor assembly coupled between the slide frame and the slide assembly, actuation of the motor assembly reciprocating the slide assembly with respect to the slide frame.

22. The apparatus of claim 12 wherein the centering arm and chain runner assembly includes a support, a drive sprocket, a driven sprocket, a drive motor, and a chain trained about the drive sprocket and driven sprocket and selectively driven by the drive motor to move the flitch along the centering arm and chain runner assembly.

23. The apparatus of claim 22 wherein the support comprises a tubular support rotatably supporting the drive sprocket and the driven sprocket in spaced-apart orientation, the tubular support including a wall defining an inside and an outside, the chain trained about the sprockets with a first bight of the chain extending outside the wall and a second bight of the chain extending inside the wall,

24. The apparatus of claim 12 wherein the centering arm and chain runner assembly comprises two centering arms, each centering arm including gear teeth, and a frame for pivotally supporting the centering arms with their gear teeth in engagement to synchronize their motion, and a motor for moving the centering arms between centering and releasing orientations.

25. The apparatus of claim 24 wherein the motor comprises a piston-and-cylinder fluid motor.

26. A flitch transport conveyor including a conveyor frame, a first dogger arm assembly for engaging a first end of the flitch, and a second dogger arm assembly for engaging a second end of the flitch.

27. The apparatus of claim 26 wherein the conveyor frame includes a first slideway and a second slideway, and each dogger arm assembly includes at least one bearing for engaging the first slideway, and a slide bar for engaging the second slideway.

28. The apparatus of claim 27 further including a first drive system for driving the first dogger arm assembly along the conveyor frame, and a second drive system for driving the second dogger arm assembly along the conveyor frame.

29. The apparatus of claim 28 wherein each of the first and second drive systems includes a drive chain, a drive sprocket, an idler sprocket, and a drive motor, the drive chains coupled to respective ones of the first and second dogger arm assemblies and extending about respective ones of the drive and idler sprockets.

30. Apparatus for shaping a flitch, the apparatus including a first shaping head assembly for shaping a first surface of the flitch, a second shaping head assembly for shaping a second surface of the flitch, and a control system for providing a shaping solution and controlling the apparatus in accordance with the shaping solution to shape the flitch.

31. The apparatus of claim 30 wherein the control system includes a scanner for scanning the flitch before shaping the flitch, the control system providing the shaping solution to optimize the yield from the flitch.

32. Apparatus for shaping a flitch, the apparatus including a first shaping head assembly for shaping a first surface of the flitch, a second shaping head assembly for shaping a second surface of the flitch, a first frame assembly for supporting the first and second shaping head assemblies, and a second frame assembly, the first frame assembly and second frame assembly together comprising at least one slideway which extends in the directions of motion of the first frame assembly, and at least one bearing engaging the at least one slideway.

33. The apparatus of claim 32 wherein the at least one bearing is provided on the first frame assembly.

34. The apparatus of claim 32 further comprising a motor coupled between the first and second frame assemblies and actuable to shift the first frame assembly transversely of the direction of motion of the flitch through the apparatus.

35. Apparatus for shaping a flitch, the apparatus including a shaping head assembly for shaping a surface of the flitch, a frame assembly, the shaping head assembly being mounted to the frame assembly by at least one slideway, at least one bearing slidable on the at least one slideway, and an actuator mounting assembly coupled between the frame assembly and the shaping head assembly to maintain the shaping head assembly in a desired position to shape the flitch.

36. The apparatus of claim 35 further including a press roll assembly mounted to the shaping head assembly and a motor for maintaining a desired pressure on the flitch as the flitch passes the press roll assembly.

37. Apparatus for shaping a flitch, the apparatus including a first shaping head assembly for shaping a first surface of the flitch, a second shaping head assembly for shaping a second surface of the flitch, a frame assembly, the first shaping head assembly being mounted to the frame assembly by at least one slideway and at least one bearing and an actuator mounting assembly coupled between the frame assembly and the first shaping head assembly to maintain the first shaping head assembly in a desired position to shape the flitch.

38. Apparatus for shaping a flitch, the apparatus including a first shaping head assembly for shaping a first surface of the flitch, a control system for providing a shaping solution and controlling the apparatus in accordance with the shaping solution to shape the flitch, a flitch transport conveyor including a first dogger arm assembly for engaging a first end of the flitch and a second dogger arm assembly for engaging a second end of the flitch to convey the flitch past the first shaping head assembly.

39. The apparatus of claim 38 wherein the flitch transport conveyor includes a conveyor frame, the conveyor frame including a first slideway and a second slideway, each dogger arm assembly includes at least one bearing for engaging the first slideway, and a slide bar for engaging the second slideway, and first and second drive systems for driving the first and second dogger arm assemblies, respectively, along the conveyor frame.

40. The apparatus of claim 39 wherein each of the first and second drive systems includes a drive chain, a drive sprocket, an idler sprocket, and a drive motor, the drive chains coupled to respective ones of the first and second dogger arm assemblies and extending about respective ones of the drive and idler sprockets.

41. The apparatus of claim 38 further including a second shaping head assembly for shaping a second surface of the flitch.

42. The apparatus of claim 41 wherein the control system includes a scanner for scanning the flitch before shaping the flitch, the control system providing the shaping solution to optimize the yield from the flitch, the flitch transport conveyor conveying the flitch first through the scanner to provide a shaping solution for the flitch and then past the first and second shaping heads to implement the shaping solution.
